(19) United States
(12) Patent Application Publication
(10) Pub. No.: US 2010/0268543 A1
(43) Pub. Date: Oct. 21, 2010

(54) METHODS AND APPARATUS TO PROVIDE CONSOLIDATED REPORTS FOR HEALTHCARE EPISODES

(76) Inventors: Joji George, Bangalore (IN); Paul Cheerankal, Bangalore (IN); Nirmal Davis, Bangalore (IN)

Correspondence Address: HANLEY, FLIGHT & ZIMMERMAN, LLC, 150 S. WACKER DRIVE, SUITE 2100, CHICAGO, IL, 60606, US

(21) Appl. No.: 12/425,221

(22) Filed: Apr. 16, 2009

(51) Int. Cl. G06Q 50/00

(52) U.S. Cl. 705/2

(57) ABSTRACT

Methods and apparatus to provide consolidated reports for healthcare episodes are disclosed herein. An example method for use with a healthcare information system includes presenting a list of reports related to a healthcare episode to a user on a display device, wherein a selection of a first one of the reports causes the first report to be displayed in a first pane; providing an input field in a second pane configured to receive data; enabling the user to import information of the first report into the input field to create a consolidated report; associating the consolidated report with one or more of the reports related to the healthcare episode; and displaying the consolidated report on the display device in a second window in response to an inquiry into one of the reports related to the healthcare episode.

### FIELD OF THE DISCLOSURE

The present disclosure relates generally to healthcare information systems and, more particularly, to methods and apparatus to provide consolidated reports for healthcare episodes.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Further, medical personnel may enter new information, such as medical history, diagnostic, financial, or treatment information into a medical information system before and/or after a completed medical procedure, analysis, and/or appointment.

### SUMMARY

An example method for use with a healthcare information system includes presenting a list of reports related to a healthcare episode to a user on a display device, wherein a selection of a first one of the reports causes the first report to be displayed in a first pane. Further, the example method includes providing an input field in a second pane configured to receive data. Further, the example method includes enabling the user to import information of the first report into the input field to create a consolidated report. Further, the example method includes associating the consolidated report with one or more of the reports related to the healthcare episode. Further, the example method includes displaying the consolidated report on the display device in a second window in response to an inquiry into one of the reports related to the healthcare episode.

An example apparatus for use with a healthcare information system includes a display generator to present a list of reports related to a healthcare episode to a user on a display device, wherein a selection of a first one of the reports causes the first report to be displayed in a first pane of a window. Further, the example apparatus includes an input field to be presented in a second pane of the window configured to receive data. Further, the example apparatus includes a consolidator to enable the user to import information of the first report into the input field to create a consolidated report. Further, the example apparatus includes an episode updater to associate the consolidated report with one or more of the reports related to the healthcare episode, wherein the display generator is to display the consolidated report in a second window on the display device in response to an inquiry into one of the reports related to the healthcare episode.

An example method for use in healthcare information system includes populating an episode report list with a plurality of reports related to a healthcare episode in response to a selection of a first one of the reports. Further, the example method includes displaying a first window on a display device including a first section to include information associated with the first one of the reports and a second section to include information related to a consolidated report associated with the healthcare episode, wherein the consolidated report is to include a consolidation of information related to the healthcare episode. Further, the example method includes in response to an engagement of an option, displaying a second window on the display device including a third section to include a list of reports corresponding to the reports of the episode report list, a fourth section to include a selected report corresponding to a selected element of the list, and a fifth section to include an input field configured to receive data related to the consolidated report. Further, the example method includes storing information entered into the input field as the consolidated report. Further, the example method includes associating the consolidated report with one or more of the reports related to the healthcare episode.

An example machine readable medium has instructions stored thereon that, when executed, cause a machine to present a list of reports related to a healthcare episode to a user on a display device, wherein a selection of a first one of the reports causes the first report to be displayed in a first pane of a first window. Further, the example machine readable medium has instructions stored thereon that, when executed cause a machine to provide an input field in a second pane of the first window configured to receive data. Further, the example machine readable medium has instructions stored thereon that, when executed cause a machine to enable the user to import information of the first report into the input field to create a consolidated report. Further, the example machine readable medium has instructions stored thereon that, when executed cause a machine to associate the consolidated report with one or more of the reports related to the healthcare episode. Further, the example machine readable medium has instructions stored thereon that, when executed cause a machine to display the consolidated report on the display device in a second window in response to an inquiry into one of the reports related to the healthcare episode.

### BRIEF DESCRIPTION OF THE DRAWINGS

FIG. 1 is a block diagram of an example healthcare information system.

FIG. 2 is a block diagram of an example apparatus that may be used to implement the example report consolidation module of FIG. 1.

FIG. 3 is an example screenshot illustrative of an example display associated with the example report consolidation module of FIGS. 1 and/or 2 and/or the example machine readable instructions of FIG. 5.

FIG. 4 is an example screenshot illustrative of an example display associated with the example report consolidation module of FIGS. 1 and/or 2 and/or the example machine readable instructions of FIG. 5

FIG. 5 is a flow diagram representative of example machine readable instructions that may be executed to implement the example report consolidation module of FIGS. 1 and/or 2.

FIG. 6 is a block diagram of an example processor system that may be used to execute the machine readable instructions of FIG. 5 to implement the example report consolidation module of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The example methods, apparatus, systems, and/or articles of manufacture described herein can be used to provide consolidated reports for healthcare episodes. While healthcare episodes can include a single healthcare event (e.g., an examination, a scan, a test, an appointment, a treatment, a procedure such as surgery, etc.), healthcare episodes often include a plurality of related events that may span across different modalities. Reports, records, data, and/or other information (which are sometimes referred to herein collectively as reports) associated with related healthcare events are typically stored (e.g., on an electronic storage medium) independently. To gain a full understanding of the entire healthcare episode (e.g., during the process of diagnosing and/or developing a medical strategy, etc.), healthcare practitioners (e.g., physicians, surgeons, support staff, etc.) typically review multiple reports associated with multiple events of the healthcare episode.

Conventional systems impose upon the practitioners the task of separately accessing and analyzing each report associated with the episode. That is, practitioners are typically required to access and review most, if not all of the medical history associated with the episode including, for example, clinical images (e.g., x-rays, magnetic resonance imaging (MRI) scans, ultrasound images, etc.), lab results, and/or any other related information, such as physician notes, findings, recommendations, treatments, follow-up information, prescriptions, information related to a closure of the healthcare episode, etc.

As an illustrative healthcare episode, a female patient identifying a solid lump formation in each breast may inform a physician of the lumps. To diagnose and/or treat the patient, the physician will likely subject the patient to a plurality of tests spanning across a plurality of modalities. In this example, the patient is first asked to undergo a mammography. The resulting mammography report includes images and the physician's findings, conclusions, and/or instructions regarding the mammography results. The findings of the physician in this example case read as follows: “Mammo report for mammo procedure of May 1, 2008—The first mass was in the retroareolar region, with minimal lobulated contours and a heterogeneous pattern in which some membrane-like tubular structures were seen. It had peripheral calcification and measured twenty mm. The second mass was located in the upper outer quadrant and its contour was partially obscured by the normal breast tissue. This second mass measured twenty-five mm. Both masses were benign.” In this example, the mammography report is electronically stored.

Perhaps several days or weeks after mammography, the physician asks the patient to undergo an ultrasound. The resulting ultrasound report includes images and the physician's finding, conclusions, and/or instructions regarding the ultrasound results. The findings of the physician in this example case read as follows: “Ultrasound report for ultrasound procedure of May 10, 2008—On ultrasound examination, both lesions were well circumscribed and had curvilinear hypoechogenic band-like structures that were collected together without cystic fluid. They were solid lesions. Ultrasound imaging showed no vascularity in either lesion. The ultrasound appearance of both lesions was felt to be compatible with a trapped germinal layer within the cyst.” The ultrasound report is electronically stored separate from the mammography report.

Perhaps several days or weeks after the ultrasound, the physician asks the patient to undergo an MRI scan. The resulting MRI report includes images and the physician's findings conclusions, and/or instruction regarding the MRI results. The findings of the physician in this example case read as follows: “MRI report for MRI procedure of May 15, 2008—During the MRI procedure it was found that the left breast suspected regions have higher washout curves than those of the right breast.” The MRI report is electronically stored separate from the mammography report and separate from the ultrasound report.

When the physician or any other practitioner desires or needs to investigate this example healthcare episode, the mammography report, the ultrasound report, and the MRI report would be separately accessed and reviewed. That is, each of the reports provides the reviewing practitioner with different results and findings due to the different capabilities of the individual modalities described above. In most healthcare situations, these different findings are needed to thoroughly and accurately diagnose and/or treat a patient.

The example methods, apparatus, systems, and/or articles of manufacture described herein enable a practitioner to create a consolidated report encompassing the findings and/or results of previous and current reports and/or information related to follow-ups, conclusions, and/or closures of a healthcare episode. In particular, the example methods, apparatus, systems, and/or articles of manufacture described herein provide the practitioner with an option of summarizing current and/or previous findings into a consolidated report that can be stored in association with one or more of the reports of a healthcare episode. Subsequent access of the reports related to the episode causes a presentation of the example consolidated report to the accessing practitioner.

As described in greater detail below, the example consolidated reports significantly reduce or eliminate the task of separately reviewing past reports and findings of previous exams, tests, or procedures. To continue the above example, a practitioner accessing the MRI report on a system implementing the example methods, apparatus, systems, and/or articles of manufacture described herein will be presented with the MRI report along with a consolidated report incorporating or summarizing the findings of the mammography, the ultrasound, and the MRI procedure. For example, the consolidated report for the above example reads as follows: “Right breast has peripheral calcification and measured twenty mm with no vascularity in either lesion which makes it suspected as cyst and the left breast (measured twenty-five mm) suspected region has higher washout curves.” In some instances, if the physician originally reviewing the MRI report does not create a consolidated report, another physician accessing the MRI report at a later time can create the consolidated report. Additionally or alternatively, certain physicians (e.g., authorized and/or authenticated practitioners) accessing the reports can edit existing consolidated reports. Further, if the example patient undergoes any follow-up examinations, the details related thereto may be added to the consolidated report in a similar manner as information associated with a most recent clinical report (e.g., the MRI scan). If the example patient is successfully treated and the healthcare episode is determined to be complete (e.g., by one or more practitioners), the details related to the closure of the episode may be added to the consolidated report in a similar manner as information associated with the a most recent clinical report (e.g., the MRI scan).

In addition, the example methods, apparatus, systems, and/or articles of manufacture described herein assist practitioners in generating the example consolidated reports described herein. For example, the presentation of the MRI report described above may also include a list of related exams or procedures such as the mammography and the ultrasound. Selecting one or more of the elements of the list presents the practitioner with the corresponding report. One or more aspects of the presented report can be imported, attached, copied, and/or otherwise incorporated into to the example consolidated report, thereby reducing any extra time taken to create the consolidated report.

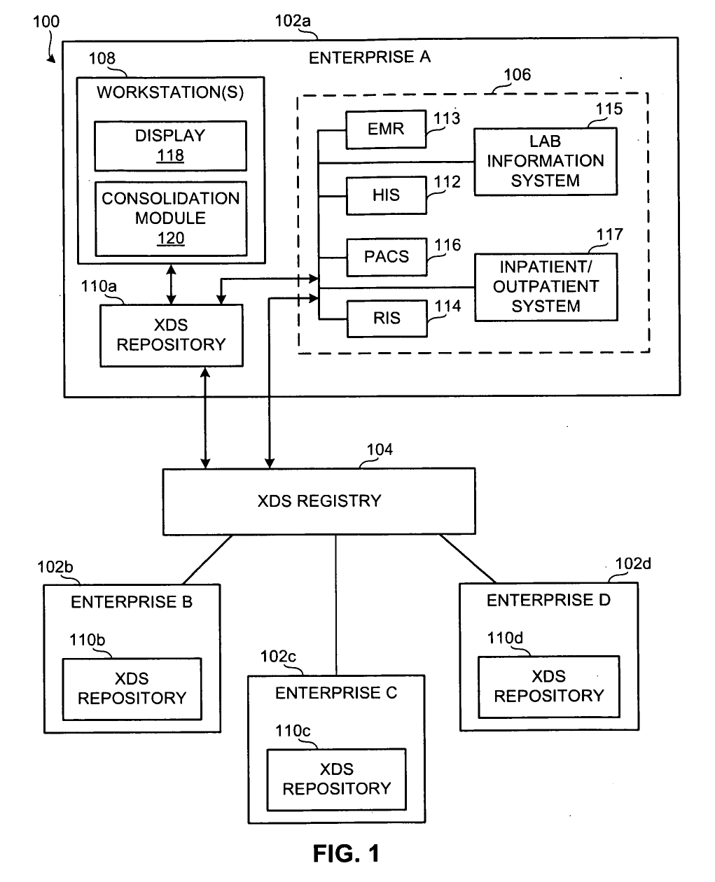

FIG. 1 is a block diagram of an example medical data system 100 capable of implementing the example methods, apparatus, systems, and/or articles of manufacture described herein to provide a consolidated report for a healthcare episode. The example medical data system 100 of FIG. 1 includes a plurality of healthcare enterprises 102a-d. In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown in FIG. 1 for purposes of brevity and not limitation.

The example medical data system 100 of FIG. 1 implements an Integrating the Healthcare Enterprise (IHE) Cross Enterprise Document Sharing (XDS) integration profile to facilitate the sharing (e.g., registration, distribution, access, etc.) of medical data among the healthcare enterprises 102a-d (referred to as an Affinity Domain in IHE XDS terminology) via a common registry 104. The XDS profile includes a common set of standards or policies for the healthcare enterprises 102a-d, which agree to share medical data using a common infrastructure. While the example medical data system 100 of FIG. 1 is shown as implemented by a XDS integration profile, any additional or alternative medical data sharing system (e.g., any health information exchanges (HIEs) and/or regional health information organizations (RHIOs) designed to enable a plurality of healthcare enterprises to exchange healthcare information) can be used to implement the example methods, apparatus, systems, and/or articles of manufacture described herein. Moreover, the example methods, apparatus, systems, and/or articles of manufacture described herein may be implemented on a medical data system 100 without information sharing capabilities, such as a standalone physician office or clinic.

The example hospital 102a includes a healthcare information system 106, one or more workstations 108, and a repository 110a. The healthcare information system 106 includes a hospital information system (HIS) 112, an electronic medical record system (EMR) 113, a radiology information system (RIS) 114, a lab information system 115, a picture archiving and communication system (PACS) 116, and an inpatient/outpatient system 117. In the illustrated example, the hospital information system 112, the electronic medical record system 113, the radiology information system 114, the lab information system 115, the PACS 116, and the inpatient/outpatient system 117 are housed in the hospital 102a and locally archived. However, in other implementations, one or more elements of the example healthcare information system 106 may be housed one or more other suitable locations. Furthermore, one or more components of the medical information system 106 may be combined and/or implemented together. For example, the radiology information system 114 and/or the PACS 116 may be integrated with the hospital information system 112; the PACS 116 may be integrated with the radiology information system 114; and/or the six example information systems 112, 113, 114, 115, 116, and/or 117 may be integrated together. Preferably, information (e.g., test results, observations, diagnosis, discharges, admissions, findings, reports, etc.) is entered into the elements of the example healthcare information 106 by healthcare practitioners (e.g., radiologists, physicians, technicians, administrators, etc.) before, after, and/or during a patient examination and/or testing session. In some examples, the equipment (e.g., an MRI machine) of these systems (e.g., the PACS 116) stores the information (e.g., an MRI scanned image) automatically upon acquiring the information.

The hospital information system 112 stores healthcare information such as clinical reports, patient information, practitioner information, and/or financial data received from, for example, personnel at a hospital, clinic, and/or a physician's office. The EMR system 113 stores information related to patients and/or practitioners, medical histories, current treatment records, etc. The radiology information system 114 stores information such as, for example, radiology reports, x-ray images, messages, warnings, alerts, patient scheduling information, patient demographic data, patient tracking information, and/or physician and patient status monitors. Additionally, the radiology information system 114 enables exam order entry (e.g., ordering an x-ray of a patient) and image and film tracking (e.g., tracking identities of one or more people that have checked out a film).

The lab information system 115 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116. The inpatient/outpatient system 117 stores information related to the admission and discharge of patients such as follow up schedules, patient instructions provided by a practitioner, prescription information, presenting symptoms, contact information, etc.

While example types of information are described above as being stored in certain elements of the healthcare information system 106, different types of healthcare data may be stored in one or more of the hospital information system 112, the EMR system 113, the radiology information system 114, the lab information system 115, the PACS 116, and/or the inpatient/outpatient system 117. Further, the information stored in these elements may overlap and/or share types of data.

The hospital information system 112, the EMR system 113, the radiology information system 114, the lab information system 115, the PACS 116, and/or the inpatient/outpatient system 117 may be in communication via, for example, a Wide Area Network (WAN) such as a private network or the Internet. More generally, any of the coupling(s) described herein, such as the coupling(s) between the registry 104 and any of the enterprises 102a-d, may be via a network. In such instances, the network may be implemented by, for example, the Internet, an intranet, a virtual private network, a wired or wireless Local Area Network, and/or a wired or wireless Wide Area Network. In some examples, the healthcare information system 106 also includes a broker (e.g., a Mitra Imaging's PACS Broker) to allow medical information and medical images to be transmitted together and stored together.

In some examples, information stored in one or more components of the medical information system 106 is formatted according to the HL-7 clinical communication protocol, the Digital Imaging and Communications in Medicine (DICOM) protocol, and/or any other suitable standard and/or protocol. The equipment used to obtain, generate, and/or store the information of the medical information system 106 may operate in accordance with the HL-7 clinical communication protocol, the DICOM protocol, and/or any other suitable standard and/or protocol.

The repository 110a, which is shown as an XDS repository in the example of FIG. 1, facilitates the sharing of healthcare documents generated by the medical information system 106 with other enterprises (e.g., enterprises 102b-d). In particular, the repository 110a receives images, medical reports, administrative information, financial data, insurance information, and/or other healthcare information from the healthcare information system 106 and stores such information in, for example, a database or any suitable data structure. Thus, to use XDS terminology, the medical information 106 is a document source that provides the repository 110a clinical data to be shared among the enterprises 102a-d. As shown in the example of FIG. 1, each of the enterprises 102b-d includes an XDS repository 110b-d that functions in a similar manner as the repository 110a of the hospital 102a.

Further, the repository 110a receives metadata associated with the images, medical reports, administrative information, financial data, insurance information, and/or other healthcare information from the medical information system 106 and forwards the metadata to the registry 104, which stores the metadata in a database 118. The metadata is used by the registry 104 to index the healthcare information stored at the repository 110a (along with the information stored at the repositories of the other enterprises 102b-d). The metadata corresponds to one of more types of identifying information (e.g., identification numbers, patient names, record numbers, social security numbers, payment status indicators, or any other identifying) associated with, for example, medical reports stored at the repository 110a. The registry 104 is capable of receiving queries into the contents of the repositories (e.g., the repository 110b of enterprise 102b) of the medical data system 100 and using the indexed metadata to satisfy the queries. For example, the registry 104 can perform a search of its contents and provide feedback (e.g., requesting clinical data or an indication of the lack thereof) regarding the same to one or more of the enterprises 102a-d and/or, more specifically, the repositories 110a-d.

The workstation(s) 108 may be any equipment (e.g., a personal computer) capable of executing software that permits electronic data (e.g., medical reports) and/or electronic medical images (e.g., x-rays, ultrasounds, MRI scans, clinical reports, test results, etc.) to be acquired, stored, or transmitted for viewing and operation. The workstation(s) 108 receive commands and/or other input from a user (e.g., a physician, surgeon, nurse, or any other healthcare practitioner) via, for example, a keyboard, mouse, track ball, microphone, etc.

The workstation(s) 108 can communicate with each other, the healthcare information system 106, and/or the XDS repository 110a and registry 104 to obtain shared medical information and convey the same to the user of the workstation(s) 108 via, for example, a display 118. Further, the workstation(s) 108 are capable of implementing a user interface to enable a healthcare practitioner to interact with the medical data system 100 and/or the registry 104 and the components thereof. In some examples, the user interface enables a search of one or more components or elements of the medical data system 100 and/or one or more external databases containing relevant healthcare information. A healthcare practitioner can use such a user interface to search medical resources using different criteria such as, for example, a patient name, a patient identification number, a social security number, date(s) of treatment(s), type(s) of treatment, and/or any other suitable search criteria.

To interact with one or more components of the medical information system 106, the workstation(s) 108 include and/or implement one or more applications. The application(s) 118 are programmed to, for example, retrieve information from a corresponding component of the healthcare information system 106, configure equipment associated with a corresponding component of the healthcare information system 106, present data associated with a corresponding component of the healthcare information system 106, and/or otherwise interact with one or more components of the healthcare information system 106. In the example of FIG. 1, dedicated application(s) are configured to interact with specific component(s) of the healthcare information system 106. For example, a PACS application is used to interact with the PACS 116, an inpatient/outpatient application is used to interact with the inpatient/outpatient system 117, etc. In some examples, one or more applications may be configured and/or programmed to interact with more than one element of the healthcare information system 106.

To provide an example consolidated report for a healthcare episode as described herein, the workstation(s) 108 of FIG. 1 include an example report consolidation module 120. While the example report consolidation module 120 of FIG. 1 is shown as implemented at the workstation(s) 108, the example report consolidation module 120 can be implemented in additional or alternative elements and/or locations in the example medical data system 100 of FIG. 1 and/or any other type of medical data system. For example, the consolidation module 120 may be implemented in the one or more of the XDS repositories 110a-d, the XDS registry 104, and/or one or more elements of the medical information system 106 (e.g., the hospital information system 112, the electronic medical record system 113, the radiology information system 114, the lab information system 115, the PACS 116, and/or the inpatient/outpatient system 117).

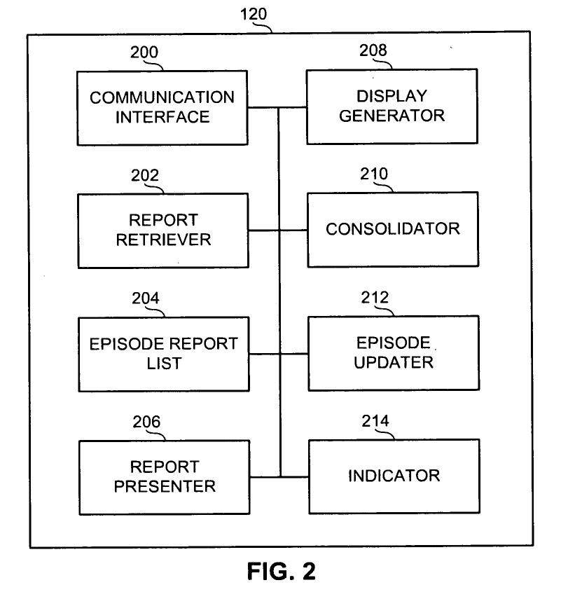

As described in greater below in connection with FIG. 2, the example consolidation module 120 of FIG. 1 enables a user to create and/or utilize a consolidated report encompassing findings associated with a plurality of previous procedures, exams, treatments results, etc. The example consolidation module 120 reduces or eliminates the need for separately accessing and/or reviewing the reports of a medical history during, for example, a diagnosis or and/or treatment process. Additionally, the example consolidation module 120 enables a practitioner to efficiently generate the consolidated report by providing direct access to one or more reports associated with previous procedures, exams, treatment results, etc. and by providing the ability to import, attach, copy, and/or otherwise incorporate the previous reports into to the example consolidated report.

FIG. 2 is a block diagram of an example apparatus that may be used to implement the example report consolidation module 120 of FIG. 1. In the illustrated example of FIG. 2, the example report consolidation module 120 includes a communication interface 200, a report retrieve 202, an episode report list 204, a report presenter 206, a display generator 208, a consolidator 210, an episode updater 212, and an indicator 214. While an example manner of implementing the report consolidation module 120 of FIG. 1 has been illustrated in FIG. 2, one or more of the elements, processes and/or devices illustrated in FIG. 2 may be combined, divided, re-arranged, omitted, eliminated and/or implemented in any other way. Further, the example communication interface 200, the example report retriever 202, the example episode list 204, the example report presenter 206, the example display generator 208, the example consolidator 210, the example episode updater 212, the example indicator 214, and/or, more generally, the report consolidation module 120 of FIG. 2 may be implemented by hardware, software, firmware and/or any combination of hardware, software and/or firmware. Thus, for example, any of the example communication interface 200, the example report retriever 202, the example episode report list 204, the example report presenter 206, the example display generator 208, the example consolidator 210, the example episode updater 212, the example indicator 214, and/or, more generally, the report consolidation module 120 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example communication interface 200, the example report retriever 202, the example episode report list 204, the example report presenter 206, the example display generator 208, the example consolidator 210, the example episode updater 212, the example indicator 214, and/or, more generally, the report consolidation module 120 of FIG. 2 are hereby expressly defined to include a tangible medium such as a memory, DVD, CD, etc., storing the software and/or firmware. Further still, the example report consolidation module 120 of FIG. 2 may include one or more elements, processes and/or devices in addition to, or instead of, those illustrated in FIG. 2, and/or may include more than one of any or all of the illustrated elements, processes and devices.

To interact with one or more elements of the workstation(s) 108 and/or the medical information system 106 of FIG. 1, the example consolidation module 120 of FIG. 2 includes the communication interface 200. For example, the communication interface 200 receives data, instructions, and/or any other suitable information from one or more of the elements of the consolidation module 120 and conveys the same (e.g., after formatting the data accordingly) to a designated application of the workstation(s) 108. Further, the communication interface 200 receives data, instructions, and/or any other suitable information from application(s) of the workstation(s) 108 and/or other elements of the medical data system 100 and conveys the same to designated element(s) of the consolidation module 120. In some examples, one or more of the elements of the example consolidation module 120 (e.g., the display generator 208, the indicator 214, etc.) communicate directly with the application(s) of the workstation(s) 108 without passing through the communication interface 200.

To gather information related to a healthcare episode being reviewed by a user of the consolidation module 120, the consolidation module 120 includes the report retriever 202. In particular, the example report retriever 202 retrieves reports associated with the healthcare episode from, for example, the medical information systems 106 and/or the XDS repository 110a of the first enterprise 102a and/or one or more other medical information systems of the other healthcare enterprises 102b-d and/or XDS repositories 110b-d. To continue the example described above involving the patient presenting a lump in both breasts, the example report retriever 202 retrieves the mammography report from the PACS 116 of the first enterprise 102a. Further, the example report retriever 202 retrieves the ultrasound report from the XDS repository 110b of the second enterprise 102b via the XDS registry 104. The XDS repository 110b of the second enterprise 102b may have received the ultrasound report from a PACS implemented at the second enterprise 102b.

In the illustrated example, the report(s) gathered by the report retriever 202 are stored in the episode report list 204. Thus, previous and current reports (or electronic copies thereof) associated with the healthcare episode are locally stored in the example consolidation module 120. In some examples, the reports are locally stored in the episode report list 204 for the time period during which the consolidation module 120 is being used to review the healthcare episode. In some examples, the episode report list 204 stores the reports for shorter or longer periods of time. As described above, the reports include images, findings, notes, observations, treatment instructions, results, etc. associated with the corresponding exam, test, procedure, etc. In some examples, the episode report list 204 includes reports dedicated to follow-up appointments and/or episode closures (e.g., checklist(s), notes, post-treatment instructions, etc.).

To provide access to the contents of the episode report list 204, the example consolidation module 120 includes the report presenter 206. As described above, the example consolidation module 120 enables a user thereof to review previous reports of the healthcare episode. In particular, the example consolidation module 120 can receive requests from the user for reports associated with previous exams, procedures, tests, etc. The example report presenter 206 responds to such requests by accessing the episode report list 204, retrieving a requested report, and preparing the same for presentation to the user via, for example, the display 118 of FIG. 1. As described in greater detail below, example requests for reports include making a selection from a list of available past and current reports.

To communicate and interact with the user, the example consolidation module 120 includes the display generator 208. In particular, the example display generator 208 of FIG. 2 generates a display configuration capable of being interpreted by the display 118 of FIG. 1. The example display generator 208 receives information from one or more elements of the consolidation module 120 such as, for example, the report presenter 206, the consolidator 210, and/or the indicator 214. The example display generator 208 formats and/or configures the received information for presentation on the display 118 of FIG. 1.

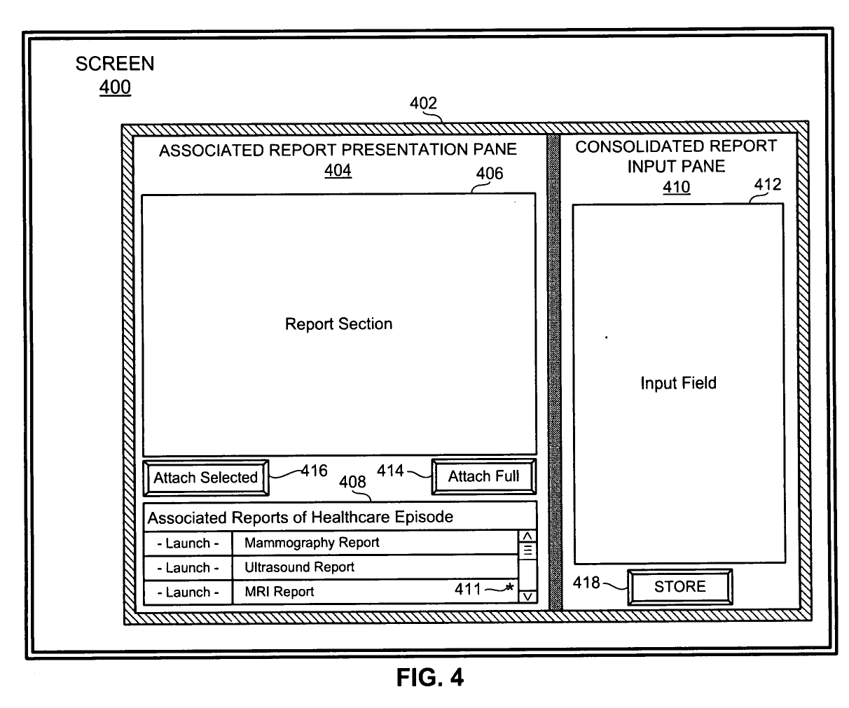

To enable the user to utilize and/or generate an example consolidated report for the healthcare episode, the example consolidation module 120 includes the consolidator 210. The example consolidator 210 of FIG. 2 provides an input field for the user to enter a consolidated report based on current and/or previous reports. As described in greater detail below in connection with FIG. 4, the example consolidator 210 can present the input field along with a presented medical report to assist the user in composing the consolidated report. Further, the example consolidator 210 of FIG. 1 enables the entirety of a previous report or any portion thereof to be imported, attached, copied, and/or otherwise incorporated into to the input field, thereby reducing any extra time taken to create the consolidated report.

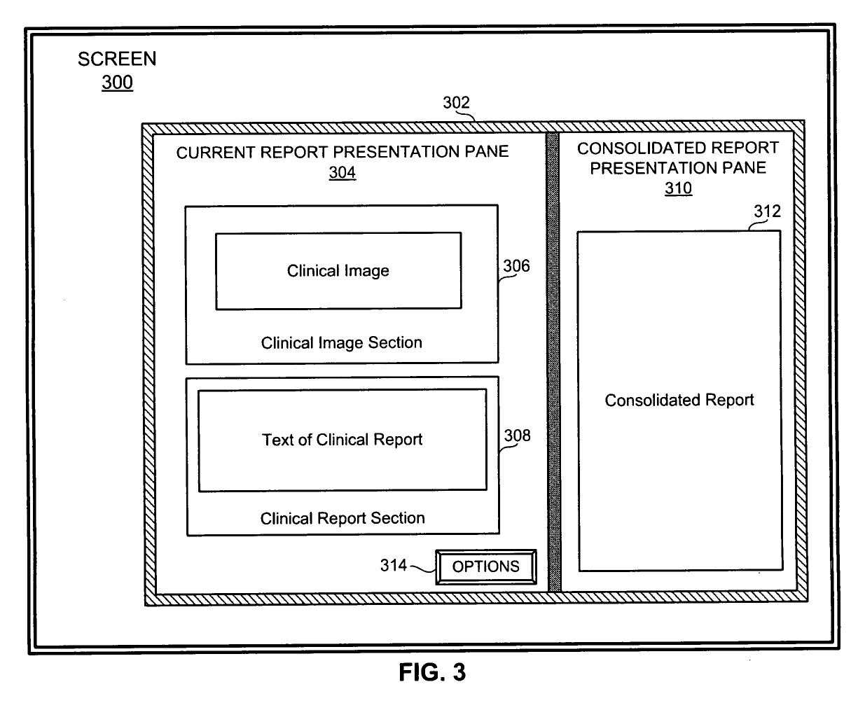

When the user indicates that the consolidated report is complete (e.g., by engaging an ‘Enter’ button), the example consolidator 210 of FIG. 2 stores the consolidated report (e.g., locally and/or in an external memory). Further, the example consolidator 210 of FIG. 2 cooperates with the display generator 208 to communicate the consolidated report to the user. As described in connection with FIGS. 3 and 4 below, the consolidator 210 can instruct the display generator 208 to dedicate a section (e.g., a pane of a display window) to the consolidated report.

The episode updater 212 of the example consolidation module 120 of FIG. 2 determines which of the reports associated with the healthcare episode (e.g., as stored in the episode report list 204) is the most recent and correlates the consolidated report stored in the consolidator 210 with the most recent report. In the illustrated example, the episode updater 212 references the episode report list 204 and one or more dates associated with the entries thereof. The example episode updater 212 then marks (e.g., sets a flag) the most recent entry and/or assigns a pointer to the most recent entry corresponding to the stored consolidated report. Thus, a user viewing the most recent report or the current report associated with the healthcare episode is automatically presented with the consolidated report, which includes, for example, a summarization of the reports occurring prior to the most recent report. The episode updater 212 can use additional or alternative methods and/or techniques to correlate the consolidated report with the most recent report associated with the healthcare episode.

In some examples, the consolidated report is correlated with more than one of the reports associated with the healthcare episode. In such instances, the episode updater 212 marks (e.g., set a flag) each of the designated reports of the episode report list 204 and/or assigns a pointer to each designated entry of the episode report list 204 corresponding to the stored consolidated report.

Further, the example episode updater 212 can correlate the consolidated report (e.g., in any suitable manner, including those described above) with one or more of the reports related to the healthcare episode in additional or alternative storage devices or instances of the reports (e.g., entries of database(s)). For example, in addition to correlating the consolidated report with the most recent report in the episode report list 204 of FIG. 2, the example episode updater 212 may correlate the consolidated report with the most recent report in the corresponding element of the medical information system 106 of FIG. 1 and/or the corresponding entry of the XDS repository 110a of FIG. 1.

The consolidation module 120 of FIG. 2 includes the indicator 214 to inform the user of an availability of the consolidated report. In particular, the example indicator 214 of FIG. 2 cooperates with the example display generator 208 such that an indication, such as an icon, is displayed in connection with the reports for which a consolidated report is available. In the illustrated example, the indicator 214 causes the episode report list 204 to store the indication (e.g., a code corresponding thereto) in association with the appropriate reports. Additionally, the indicator 214 can cause the indication to be selectable by the user to cause a display of the consolidated report.

FIGS. 3 and 4 are screenshots illustrative of an example display associated with the example report consolidation module of FIGS. 1 and/or 2. While the display generator 208 of FIG. 2 can generate any suitable display configuration, FIGS. 3 and 4 illustrate example screenshots 300 and 400 generated by the example display generator 208 of FIG. 2. The example screenshot 300 of FIG. 3 includes a first window 302 to be presented in response to an activation of the example report consolidation module 120. The example report consolidation module 120 can be triggered by, for example, a practitioner accessing a database via the workstation(s) 108 and retrieving a clinical report associated with a healthcare episode. To continue the example described above involving the patient presenting a lump in both breasts, the example first window 302 of FIG. 3 is presented by the display generator 208 in response to a practitioner accessing (e.g., requesting a copy of an electronic record) the MRI report from the PACS 116 of the medical information system 106 of FIG. 1. As described above, the MRI report is the most recent report in a series of reports spanning across different modalities (e.g., the mammography, the ultrasound, and the MRI scan). In such an instance, the MRI report is sometimes referred to herein as the current report.

In response to the accessing of the current report, the example report retriever 202 (FIG. 2) retrieves the reports associated with the healthcare episode and populates the episode report list 204 (FIG. 2). Further, the example report presenter 206 (FIG. 2) cooperates with the example display generator 208 to present the current report in one or more sections of the first window 302. In the illustrated example of FIG. 3, the first window 302 includes a current report presentation pane 304, which includes an image section 306 and a text section 308 dedicated to presenting the current report (e.g., the MRI report in the above example). The first window 302 may include additional or alternative section(s) to display the current report.

Further, the example consolidator 210 cooperates with the example display generator 208 to present the consolidated report (if a consolidated report is available) in one or more sections of the first window 302. In the illustrated example of FIG. 3, the first window 302 includes a consolidated report presentation pane 310, which includes a consolidated report section 312 dedicated to presenting the consolidated report.

The example first window of FIG. 3 also includes an ‘Option’ button 314. The example screenshot 400 of FIG. 4 includes a second window 402 to be presented in response to a selection of the ‘Option’ button 314 of FIG. 3. The example report presenter 206 cooperates with the example display generator 208 to enable the practitioner to select and view the reports associated with the healthcare episode (e.g., as stored and retrievable in the episode report list 204). In the illustrated example of FIG. 4, the second window 402 includes an associated report presentation pane 404, which includes a report section 406 dedicated to presenting at least one of the reports (e.g., images and/or text of the report) associated with the healthcare episode. The associated report presentation pane 404 also includes a list of associated reports 408. The elements of the list 408 are selectable (e.g., via ‘launch’ icons listed adjacent to the corresponding report) to be presented in the report section 406. That is, a user of the example consolidation module 120 is able to launch and view the reports associated with the healthcare episode in a concise manner and along with the consolidated report described herein.

In the example of FIG. 4, the list 408 includes an example indication 411 to indicate that a consolidated report is available for a corresponding report. As described above, the indicator 214 (FIG. 2) causes the episode report list 204 to store an indication (e.g., a code corresponding thereto) in association with the reports having a consolidated report associated therewith. The indicator 214 can also cooperate with the display generator 208 to present the indication 411 as shown in FIG. 4 and/or in other suitable location(s). Additionally, the indicator 214 can cause the indication 411 to be selectable by the user to cause a display of the corresponding consolidated report. While the example indicator 411 of FIG. 4 is shown as an asterisk, the indicator 411 may be any symbol, text message, a combination thereof, or any other suitable item.

The example consolidator 210 cooperates with the example display generator 208 to enable the practitioner to generate the consolidated report. In the illustrated example of FIG. 4, the second window 402 includes a consolidated report input pane 410, which includes an input field 412 dedicated to receiving information selected and/or written by the practitioner to comprise the consolidated report encompassing previous and/or current reports associated with the healthcare episode. As described above, practitioners can also include information related to follow-up appointment(s) and/or a closure (e.g., after a determination that the healthcare issue has been resolved) of the healthcare episode in consolidated report. Thus, the input field 412 can receive information related to follow-up appointment(s) and/or closures of healthcare episodes.

The example input field 412 of FIG. 4 provides a plurality of options to generate the consolidated report. For example, the input field 412 provides a positional cursor to facilitate an input of text (e.g., ASCII characters and/or any other suitable format of textual input). Further, the example input field 412 can receive copy/pasted data from any suitable source. In the illustrated example, the associated report presentation pane 404 includes two buttons to facilitate a copy/paste function from the currently presented report of the report section 406. In particular, an ‘Attach Full’ button 414 causes the example consolidator 210 of FIG. 2 to copy the entire current report (e.g., including images and/or texts) into the input field 412. Similarly, an ‘Attach Selected’ button 416 causes the example consolidator 210 of FIG. 2 to copy a selected (e.g., highlighted, via a cursor, text and/or images) portion of the current report into the input field 412. The copied information can be additionally edited in the input field 412 as desired by the practitioner.

When the consolidated report in the input field 412 is complete, the practitioner can engage a ‘Store’ button 418. In response, the example consolidator 210 of FIG. 2 stores the consolidated report (e.g., in memory associated with the consolidation module 120, the medical information system 106, and/or any other suitable memory).

The first and second windows 302 and 402 of the illustrated examples of FIGS. 3 and/or 4 may include additional or alternative section(s), button(s), and/or pane(s) to display the information described herein and/or additional or alternative information related to the consolidation module 120 and/or any other suitable information.

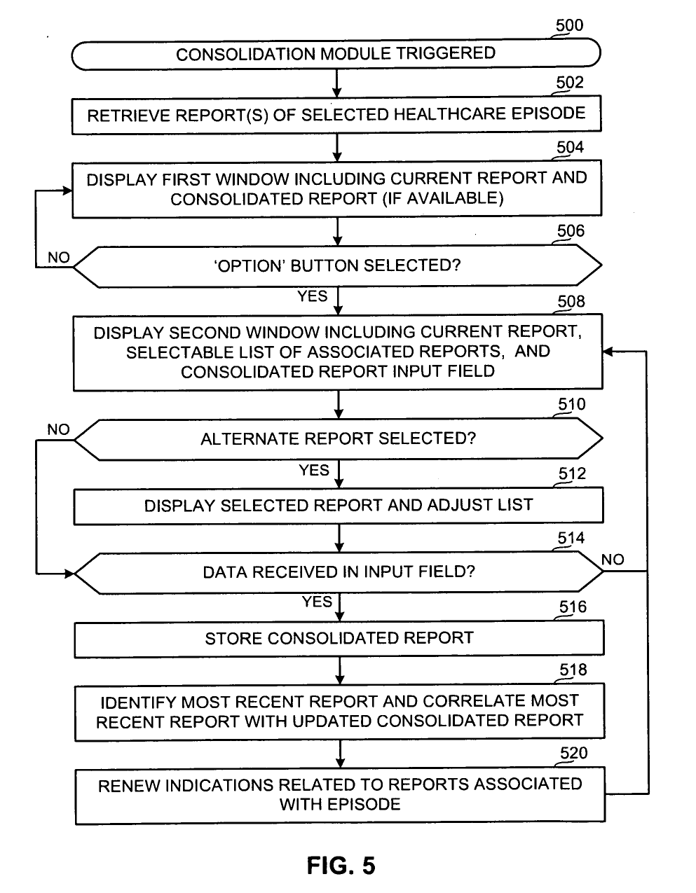

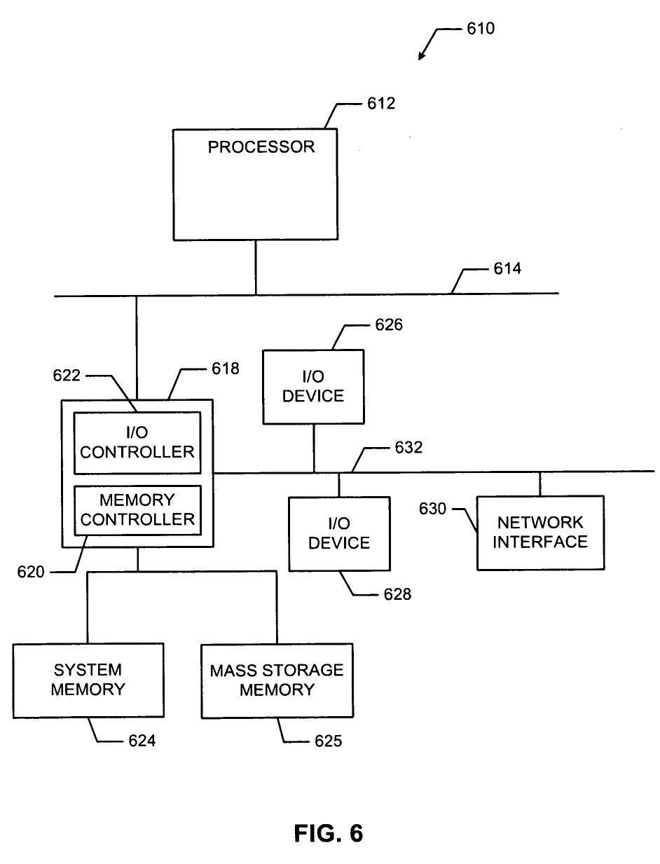

Turning to FIG. 5, the flow diagram depicted in FIG. 5 is representative of machine readable instructions that can be executed to implement the example report consolidation module 120 of FIGS. 1 and/or 2 to provide a consolidated report for a healthcare episode. The example processes of FIG. 5 may be performed using a processor, a controller and/or any other suitable processing device. For example, the example processes of FIG. 5 may be implemented in coded instructions stored on a tangible medium such as a flash memory, a read-only memory (ROM) and/or random-access memory (RAM) associated with a processor (e.g., the example processor 612 discussed below in connection with FIG. 6). Alternatively, some or all of the example processes of FIG. 5 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 5 may be implemented manually or as any combination(s) of any of the foregoing techniques, for example, any combination of firmware, software, discrete logic and/or hardware. Further, although the example processes of FIG. 5 are described with reference to the flow diagram of FIG. 5, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 5 may be performed sequentially and/or in parallel by, for example, separate processing threads, processors, devices, discrete logic, circuits, etc.

The consolidation module 120 can be triggered by, for example, a practitioner accessing a database via the workstation(s) 108 and retrieving a clinical report associated with a healthcare episode (block 500). In some examples, the consolidation module 120 is triggered in response to a retrieval of any healthcare report and/or a specific type of healthcare report (e.g., those compatible with the consolidation module, which may be every type of healthcare report or a portion thereof). In the illustrated example, when the consolidation module 120 is triggered by a selection of a report, the report retriever 202 retrieves the report(s) of the healthcare episode to which the selected report belongs (block 502). The retrieved report(s) populate the report list 204 of FIG. 2. As described herein, the report(s) of the report list 204 can be efficiently retrieved, reviewed, and/or utilized to create a consolidated report using the example consolidation module 120 and the corresponding features described herein.

The example report presenter 206 (FIG. 2) and the example consolidator 210 cooperate with the example display generator 208 to present the selected report and a consolidated report (if a consolidated report is available) to the practitioner (block 504) in a first window (e.g., the first window 302 of FIG. 3). To reference the example illustrated in FIG. 3, the current report is displayed in one or more sections of the current report presentation pane 304. Further, any available consolidated report is displayed in the consolidated report presentation pane 310 of FIG. 3, which includes a consolidated report section 312 dedicated to presenting the consolidated report.

If the practitioner engages a designated button (e.g., the ‘Option’ button 314 of FIG. 3) (block 506), a second window (e.g., the second window 402 of FIG. 4) is presented to the practitioner (block 508). In the illustrated example, the second window includes the current report, a selectable list of associated reports, and a consolidated report input field. To reference the example of FIG. 4, the second window 402 includes the associated report presentation pane 404, the selectable list 408, and the consolidated report input pane 410 to display this information.

Regarding the selectable list of associated reports, the example report presenter 206 cooperates with the example display generator 208 to enable the practitioner to select and view the reports associated with the healthcare episode (e.g., as stored and retrievable in the episode report list 204). If the practitioner selects one of the reports associated with the selected healthcare episode (e.g., in the list 408 of FIG. 4) (block 510), the contents of the selected report (e.g. clinical images, findings, treatments, diagnosis, closure information, follow-up appointment details, etc.) are presented to the practitioner in the second window and the remainder of the selectable list is adjusted (e.g., the previously selected report returned to the selectable list and/or a highlight indicating which of the reports is being display is altered to reflect the newly selected report being displayed) (block 512).

As described above, the example consolidator 210 of FIG. 2 cooperates with the example display generator 208 to enable the practitioner to generate and/or edit the consolidated report. If an consolidated report input field (e.g., the report input pane 410 of FIG. 4) receives information (e.g., selected and/or written by the practitioner) to comprise the consolidated report (block 514), the resulting consolidated report is stored (e.g., in memory associated with the consolidation module 120, the medical information system 106, and/or any other suitable memory) (block 516).

In the illustrated example of FIG. 5, when the consolidated report has been created and/or edited, the example episode updater 212 (FIG. 2) identifies the most recent report and correlates the most recent report with the updated consolidated report (block 518). Thus, a user viewing the most recent report or the current report associated with the healthcare episode is automatically presented with the consolidated report, which includes, for example, a summarization of the reports occurring prior to the most recent report. In some examples, the episode updater 212 associates the updated consolidated report with additional or alternative reports of the healthcare episode such as, for example, reports associated with follow-up appointments and/or a closure of the healthcare episode.

In the illustrated example of FIG. 5, when the consolidated report has been created and/or edited, or when the consolidated report is associated with a report that was previously unassociated with the consolidated report, the example indicator 214 (FIG. 2) renews the indications related to the reports associated with the healthcare episode (block 520). That is, the indications displayed in conjunction with reports associated with the consolidated report are updated (e.g., in the episode report list 204 of FIG. 2) to reflect any changes made regarding the associated of the consolidated report with any of the reports of the healthcare episode.

FIG. 6 is a block diagram of an example processor system 610 that may be used to implement the apparatus and methods described herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use with a healthcare information system, comprising:
presenting a list of reports related to a healthcare episode to a user on a display device, wherein a selection of a first one of the reports causes the first report to be displayed in a first pane of a first window;
providing an input field in a second pane of the first window configured to receive data;
enabling the user to import information of the first report into the input field to create a consolidated report;
associating the consolidated report with one or more of the reports related to the healthcare episode; and
displaying the consolidated report on the display device in a second window in response to an inquiry into one of the reports related to the healthcare episode.

2. A computer implemented method as defined in claim 1, wherein the consolidated report is to include a consolidation of information related to the healthcare episode.

3. A computer implemented method as defined in claim 1, wherein the second window includes an option to present the first window to edit the consolidated report.

4. A computer implemented method as defined in claim 1, further comprising storing an indication in connection with any of the reports associated with the consolidated report.

5. A computer implemented method as defined in claim 1, wherein associating the consolidated report with the one or more of the reports related to the healthcare episode comprises identifying a most recent report and associating the consolidated report with the most recent report.

6. A computer implemented method as defined in claim 1, wherein enabling the user to import information of the first report into the input field to create the consolidated report comprises enabling the user to copy and paste a portion of the information of the first report into the input field.

7. A computer implemented method as defined in claim 1, wherein enabling the user to import information of the first report into the input field to create the consolidated report comprises enabling the user to import the entire first report into the input field.

8. A computer implemented method as defined in claim 1, further comprising conveying the consolidated report to a medical information sharing system.

9. An apparatus for use with a healthcare information system, comprising:
a display generator to present a list of reports related to a healthcare episode to a user on a display device, wherein a selection of a first one of the reports causes the first report to be displayed in a first pane of a first window;
an input field to be presented in a second pane of the first window configured to receive data;
a consolidator to enable the user to import information of the first report into the input field to create a consolidated report; and
an episode updater to associate the consolidated report with one or more of the reports related to the healthcare episode, wherein the display generator is to display the consolidated report in a second window on the display device in response to an inquiry into one of the reports related to the healthcare episode.

10. An apparatus as defined in claim 9, wherein the consolidated report is to include a consolidation of information related to the healthcare episode.

11. An apparatus as defined in claim 9, wherein the second window includes an option to present the first window to edit the consolidated report.

12. An apparatus as defined in claim 9, further comprising an indicator to store an indication in connection with any of the reports associated with the consolidated report.

13. An apparatus as defined in claim 9, wherein the consolidator is to enable the user to import information of the first report into the input field to create the consolidated report by enabling the user to copy and paste a portion of the information of the first report into the input field.

14. An apparatus as defined in claim 9, wherein the consolidator is to enable the user to import information of the first report into the input field to create the consolidated report by enabling the user to import the entire first report into the input field.

15. An apparatus as defined in claim 9, further comprising a communication interface to convey the consolidated report to a medical information sharing system.

16. A computer implemented method for use in a healthcare information system, comprising:
populating an episode report list with a plurality of reports related to a healthcare episode in response to a selection of a first one of the reports;
displaying a first window on a display device including a first section to include information associated with the first one of the reports and a second section to include information related to a consolidated report associated with the healthcare episode, wherein the consolidated report is to include a consolidation of information related to the healthcare episode;
in response to an engagement of an option, displaying a second window on the display device including a third section to include a list of reports corresponding to the reports of the episode report list, a fourth section to include a selected report corresponding to a selected element of the list, and a fifth section to include an input field configured to receive data related to the consolidated report;
storing information entered into the input field as the consolidated report; and
associating the consolidated report with one or more of the reports related to the healthcare episode.

17. A computer implemented method as defined in claim 16, wherein associating the consolidated report with one or more of the reports related to the healthcare episode comprises identifying a most recent report and associating the consolidated report with the most recent report.

18. A computer implemented method as defined in claim 16, further comprising displaying an indication in connection with any of the reports associated with the consolidated reports.

19. A computer implemented method as defined in claim 16, further comprising enabling a user to import information of the selected report into the input field to create the consolidated report.

20. A machine readable medium having instructions stored thereon that, when executed, cause a machine to:
present a list of reports related to a healthcare episode to a user on a display device, wherein a selection of a first one of the reports causes the first report to be displayed in a first pane of a first window;
provide an input field in a second pane of the first window configured to receive data;
enable the user to import information of the first report into the input field to create a consolidated report;
associate the consolidated report with one or more of the reports related to the healthcare episode; and
display the consolidated report on the display device in a second window in response to an inquiry into one of the reports related to the healthcare episode.
